(19) United States
(12) Patent Application Publication
(10) Pub. No.: US 2002/0046094 A1
(43) Pub. Date: Apr. 18, 2002

(54) Method and system for delivering electronic advertisement via network

(76) Inventor: Toshitsugu Takekuma, Yokohama (JP)

Correspondence Address: Mattingly, Stanger & Malur, P.C., 104 East Hume Avenue, Alexandria, VA, 22301, US

(21) Appl. No.: 09/790,880

(22) Filed: Feb. 23, 2001

(30) Foreign Application Priority Data
Aug. 7, 2000 (JP) 2000-244021

(51) Int. Cl. G06F 17/60

(52) U.S. Cl. 705/14

(57) ABSTRACT

An advertiser registers advertisement information in a database. An advertisement requester registers advertisement request information in the database. An advertisement information providing server compares the advertisement information with the advertisement request information at predetermined intervals of time to extract the advertisement information coinciding with the advertisement request information, delivers the extracted advertisement information to the advertisement requester or an address of a destination specified by the advertisement requester. Thus, the consumer can easily get a desired advertisement.

### BACKGROUND OF THE INVENTION

The present invention relates to advertisement delivering systems and methods for delivering to consumers advertisements needed by the consumers.

Commodity information (advertisement) is provided from advertisers to consumers in conventional advertisements, for example, in advertisements published on newspapers/magazines; television commercials; advertising leaflets inserted in newspapers; and direct mails, irrespective of whether the consumers request the advertisements.

In this case, advertisements that the consumers desire to get or are completely indifferent to are provided in a mixed manner to the consumers. Thus, the consumers themselves are required to look for desired information from the advertisements.

In the case of advertising leaflets inserted in newspapers, a news dealer's shop near an advertiser's store delivers many advertisement information in many cases. There are geometrical restrictions in which some consumers cannot get desired advertisement information when they live at a place distant from the advertiser or news dealer's shop. Thus, in order to know commodity/service prices of stores from which the consumer cannot get the advertisement information, the consumer must visit the stores or inquire of the stores the information, for example, by telephone.

JP-A-5-143653 discloses a system in which a consumer can retrieve advertisement information kept as a database had by the server. According to this advertisement getting method, the consumer can extract a target advertisement from among many advertisements. However, in order to get advertisement information every day, the consumer must access the database every day. In the advertisement getting method disclosed in the publication, however, it is impossible for an consumer to subscribe to unregistered advertisements, for example, advertisement information to be published in the future.

### SUMMARY OF THE INVENTION

It is therefore an object of the present invention to provide an advertisement delivering method and system for solving the problems with the prior art.

Another object of the present invention is to provide an advertisement delivering method and system for continuing to deliver advertisement information that the consumers desire to get.

A further object of the present invention is to provide an advertisement delivering method and system in which once a consumer registers desired advertisement information or its conditions, advertisement information that satisfies the conditions is repeatedly delivered to the consumer not only when it is registered, but also after it is registered.

The means for solving the problems according to the present invention will be clarified next in the specification. A typical system comprises a unit for registering advertisement information, a unit for registering advertisement request information, and a unit for registering information on a frequency of advertisement requests. The system also comprises a unit for comparing the advertisement information and the advertisement request information based on the frequency information, a unit for extracting advertisement information that coincides with the advertisement request information as a result of the comparison, and a unit for delivering the extracted advertisement information to the advertisement requester or an address specified by the advertisement requester.

### BRIEF DESCRIPTION OF THE DRAWINGS

FIG. 1 is a block diagram of a whole system of one embodiment of the present invention;

FIG. 2 is a block diagram of one embodiment of each of information terminals 1, 4 and 5 owned by an advertiser or an advertisement requester;

FIG. 3 is a block diagram of one embodiment of an advertiser's information terminal 2 of FIG. 1, using a barcode reader;

FIG. 4 is a block diagram of an advertisement mediator's server system 3 of FIG. 1;

FIG. 5 illustrates a transition of screens sent out by the server system to input advertisement information;

FIG. 6 illustrates a start page for an advertisement information providing service;

FIGS. 7A, 7B and 7C illustrate screens appearing sequentially when the advertisement requester is registered;

FIGS. 8A, 8B and 8C illustrate screens appearing sequentially when the advertiser is registered;

FIGS. 9A and 9B respectively show data structures of databases for advertiser information and advertisement requester information;

FIGS. 10A, 10B, 10C and 10D show screens appearing sequentially when the advertisement information is registered;

FIG. 11 shows a commodity code table;

FIG. 12 is a flowchart indicative of conversion of a commodity code to a commodity name;

FIG. 13 shows a database for the advertisement information;

FIGS. 14A, 14B, 14C and 14D show screens that register contents of an advertisement request appearing sequentially;

FIG. 15 illustrates a database for advertisement request information;

FIG. 16 illustrates another example of the database for advertisement request information;

FIG. 17 illustrates an advertisement delivery flow performed when all advertisement requesters have the same retrieval frequency;

FIG. 18 illustrates retrieval frequency information;

FIG. 19 is a flowchart of deleting an advertisement whose effective term has expired;

FIG. 20 illustrates a retrieval flow performed when the retrieval frequency varies for each advertisement requester;

FIG. 21 illustrates retrieval frequency information obtained when the flow of FIG. 20 is used;

FIG. 22 illustrates a screen appearing when a screen/photograph advertisement is registered;

FIG. 23 illustrates an example of screen/photograph advertisement data;

FIG. 24 illustrates a delivered advertisement of text data alone; and

FIG. 25 illustrates a delivered advertisement containing screen/photograph advertisements.

### DETAILED DESCRIPTION OF THE EMBODIMENTS

Embodiments of the present invention will be described in more detail with reference to the accompanying drawings.

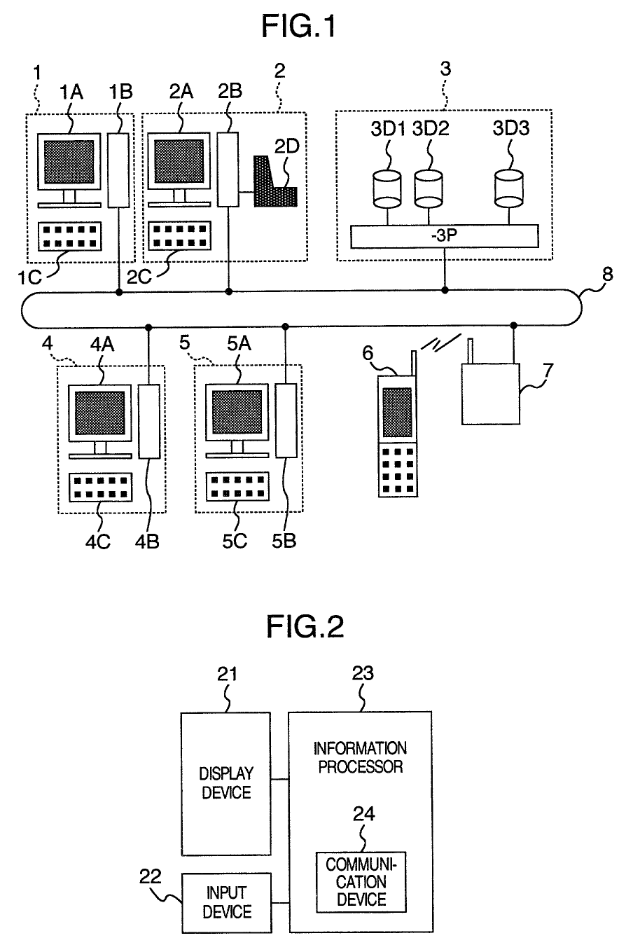

FIG. 1 illustrates an electronic advertisement delivery system as a first embodiment of the present invention. As shown in FIG. 1, the electronic advertisement delivery system comprises advertisement providers' information terminals 1, 2; and advertisement requesters' information terminal 4, 5, 6. The electronic advertisement delivery system also comprises a server system 3 that registers an advertisement/an advertisement request, retrieves an advertisement based on the contents of the advertisement request, and sends a result of the retrieval to the requester; and a network 8 which connects those devices.

Reference characters 1A, 2A, 4A and 5A each denote a display device; 1B, 2B, 4B and 5B each an information processor; and 1C, 2C, 4C and 5C each an input device. Reference character 2D denotes a device, used to identify a commodity at a cash register, such as a barcode reader terminal used, for example, in a supermarket. Reference characters 3D1, 3D2 and 3D3 each denote an information storage device; 6 a mobile communications terminal such as a portable telephone; and 7 a device that connects the communications terminal 6 and the network 8.

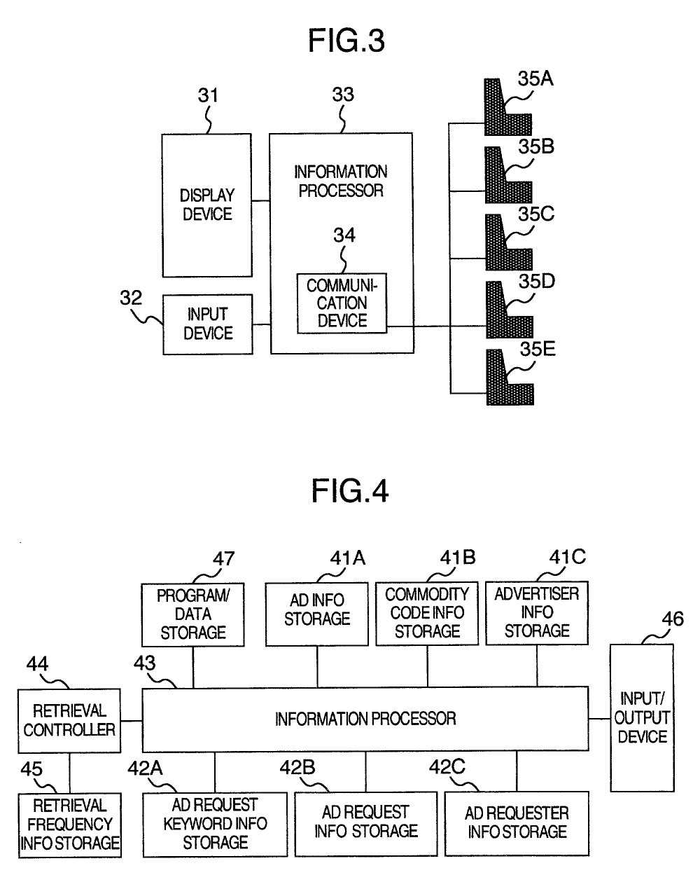

As shown in FIG. 2, the terminals 1, 4 and 5 are each composed of a display device 21 (1A, 2A, 4A, 5A), an input device 22 (1C, 2C, 4C, 5C) and an information processor 23 which includes a communications device 24 to connect those devices with the network 8. As shown in FIG. 3, the information terminal 2 comprises a system similar to that of FIG. 2 with a plurality of commodity identifying terminals such as barcode readers 35A, 35B, . . . , 35E connected to the system. This system of FIG. 3 is similar to that used in a store such as a supermarket. While FIG. 3 illustrates use of five commodity identifying terminals such as barcode readers 35A, 35B, . . . , 35E, the number of such terminals is limitless.

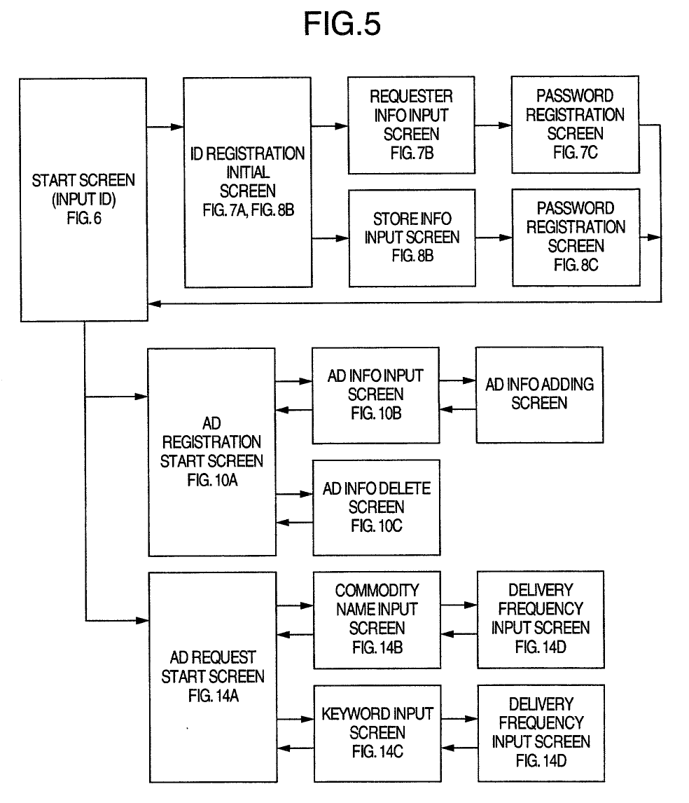

FIG. 4 illustrates the details of the advertisement mediator's server system 3. This system 3 comprises an advertisement information storage device 41A that keeps advertisement information, and a commodity code information storage device 41B that stores commodity codes such as barcodes and commodity names in corresponding relationship. The system also comprises an advertiser information storage device 41C that stores information on the advertisers, an advertisement request keyword information storage device 42A that keeps keywords to be registered by the consumers, and an advertisement request information storage device 42B which keeps information such as commodity names that the consumers register. The system further comprises an advertisement requester information storage device 42C that keeps information on advertisement requesters (consumers), a retrieval frequency information storage device 45 that keeps information on database retrieval frequency to deliver to advertisement requesters advertisements that the advertisement requesters desire; a retrieval controller 44, an information processor 43, and an input/output device 46.

Operation of the inventive electronic advertisement delivery system will be described in detail next. First, a user registering method performed by each of an advertiser and an advertisement requester in the present system will be described with reference to FIGS. 5 through 9.

FIG. 5 illustrates a transition of screens that the server 3 sends the user terminal (1, 2, 4, 5, 6) in the user registration. A program required for sending a screens and its data and for performing other processes is stored by the information processor 43 in the readable/writable program/data storage device 47. The program is read and executed by the information processor 43 to thereby perform an advertisement delivering process. The program/data storage device is removable from the information processor 43 and is connectable to other information processors (not shown) in use. The program/data is sent/received to/from other information processors via the network.

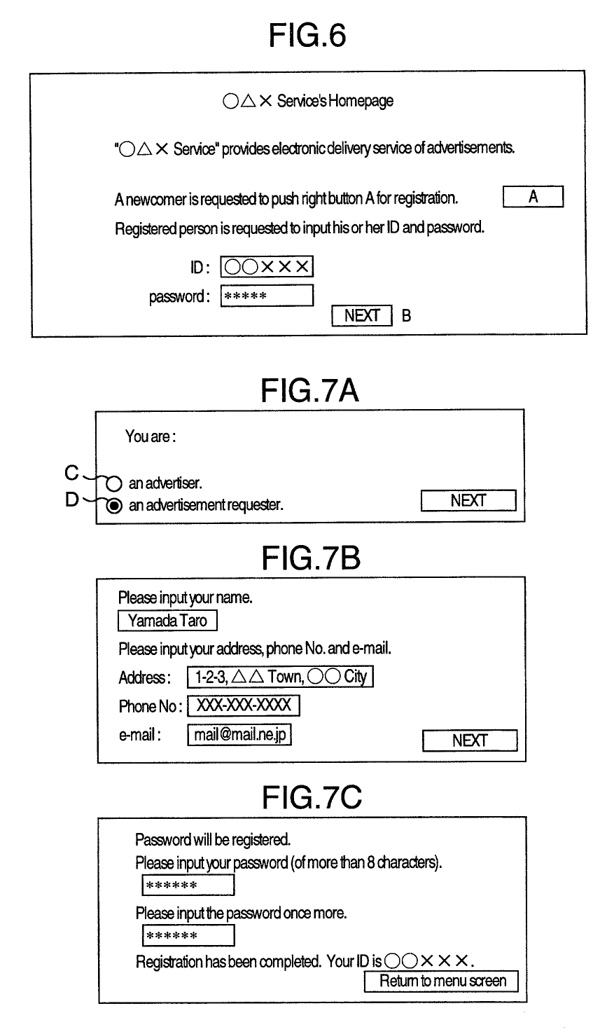

FIG. 6 illustrates a start page of Internet homepages of this service. When this service is received, personal authentication is performed for ensuring security. In this case, the server 3 performs personal authentication by having the user to register his or her ID and password and then by checking them.

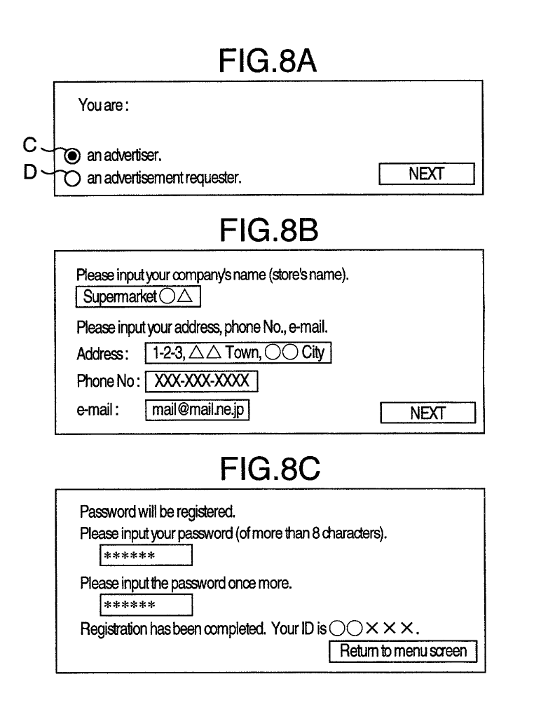

When a user who has no his or her ID and password registers him or her, the user is required to depress a button A on the start screens. When the button A is depressed, a screen of FIG. 7A or 8A appears. In a screen transition process of FIGS. 7B and 7C, an advertiser who has no ID and password is prompted to perform user registration. An advertisement requester who has no ID and password is prompted to perform user registration in a screen transition process of FIGS. 8B and 8C.

Registration is made, for example, of a name (advertisement requester's name or advertiser's name/store name), address, telephone number, mail address, ID, and password. While the example of user registration using the Internet has been illustrated, the user can make an application for user registration in a conventional written form. In this case, the advertisement mediator may make the user registration. The items to be inputted in this user registration are by way of example only and not limited to those items.

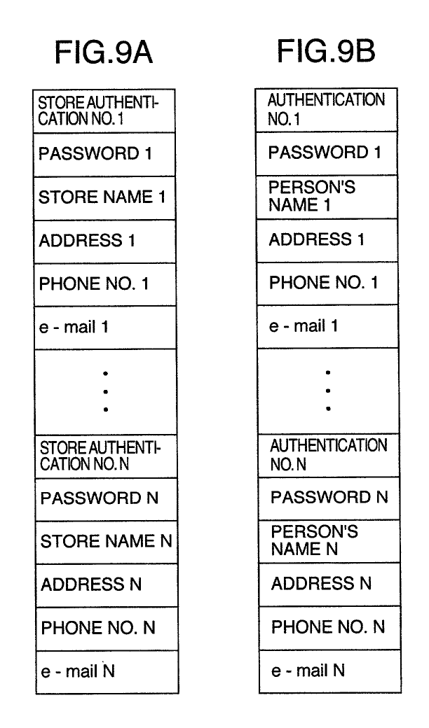

The input advertiser's information is stored as his or her store authentication number, password, store name, address, telephone number, and e-mail address for his or her ID, as shown in FIG. 9A, in a data area of the advertiser's information storage device 41C of FIG. 4. The input advertisement requester information is stored as his or her authentication number, password, name, address, telephone number, and e-mail address for his or her ID, as shown in FIG. 9B, in a data area of the advertisement requester information storage device 42C of FIG. 4.

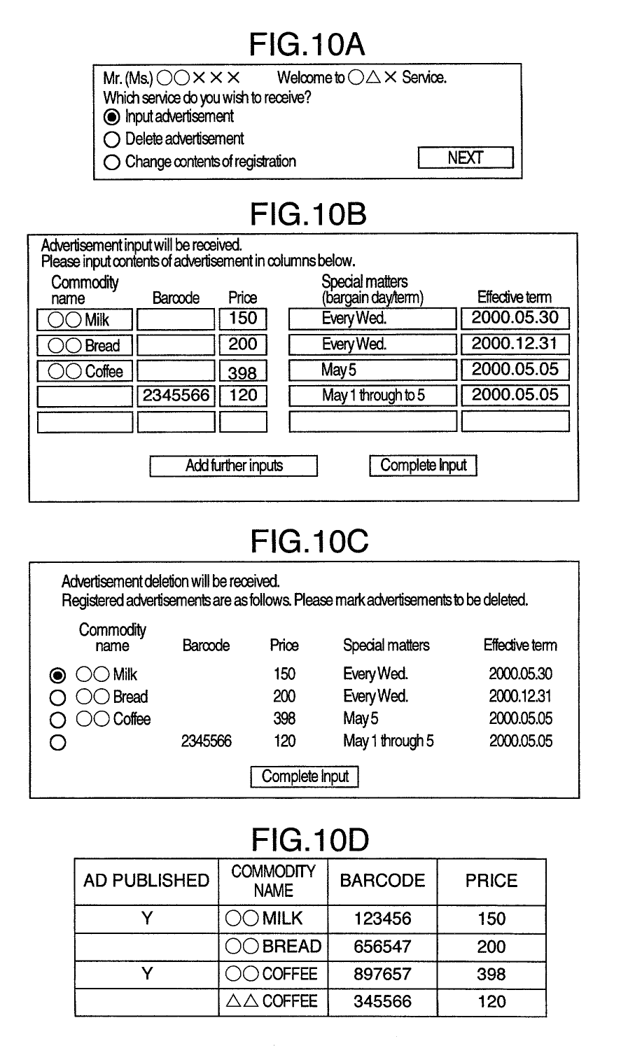

When a button B is depressed on a start page (FIG. 6), the personal authentication is completed in the server and ID indicates the advertiser, guidance for inputting advertisement information is displayed. A method of inputting the advertisement information by the advertiser will be explained with reference to FIGS. 10A-10D.

FIG. 10A illustrates a start screen for inputting the advertisement information. This screen illustrates that the advertiser can select “input advertisement”, “delete advertisement”, or “change the contents of registration”. When “input advertisement” is selected, a guidance screen of FIG. 10B is displayed that prompts the advertiser to input advertisement information. This screen has areas for items necessary for the advertisement, for example, a commodity name, a code to determine the commodity (for example, a barcode), price, special matters representing a bargain day and its term, and an effective term or deadline of the advertisement that the user can input. When “delete advertisement” is selected in FIG. 10A, a screen of FIG. 10C is displayed. This screen displays a list of advertisements already registered. When the advertiser responds to the server by selecting an advertisement to be deleted from among the registered advertisements, the server deletes the advertisement. When “registered the change contents” is selected in FIG. 10A, both screens of FIGS. 10C and 10B are displayed.

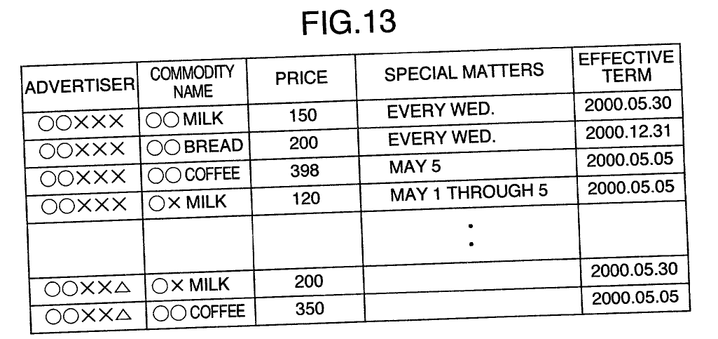

The advertisement information (advertiser's ID, commodity name, price, special matters and effective term or deadline) of advertisement) inputted in this way is stored as shown in FIG. 13 in the advertisement information storage device 41A of FIG. 4 where the advertiser's ID corresponds to the remaining information.

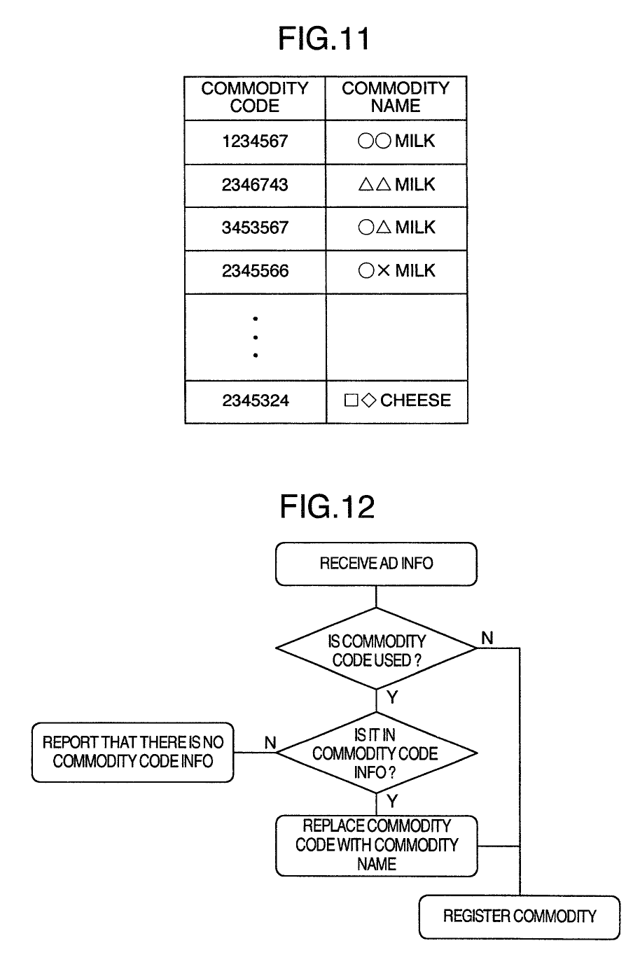

A barcode (commodity code) is used to input advertisement information, as shown in FIG. 10B. When a value of a barcode is input without being changed to a commodity name, for example, by the store terminal 2, and received by the input/output device 46, the information processor 43 replaces the commodity code with the corresponding commodity name in a process of FIG. 12 based on a commodity code vs. commodity name table such as shown in FIG. 11 and stored in the commodity code information storage device 41B, and then stores it in the storage device 41A.

If the advertiser has employed the barcode reader terminal of FIG. 3, information on the commodity name, barcode and price is kept as a price lookup table in a storage device (not shown, but included in the store terminal 2) of the advertiser's information device. The store terminal 2 may beforehand prepares therein a version of the lookup table that additionally contains information about whether to publish those items of the information in an advertisement and send the version to the server. An effective term or deadline of the advertisement at this time may be default and expires on a day of data delivery.

When the button B is depressed on the start page (FIG. 6) to complete the personal authentication and the inputted ID is a registered advertisement requester's one at that time, the advertisement request registration screen (FIG. 12A) is displayed.

Two kinds of examples of registration by a commodity name and registration by a keyword related to a commodity will be illustrated as a method of registering the advertisement request.

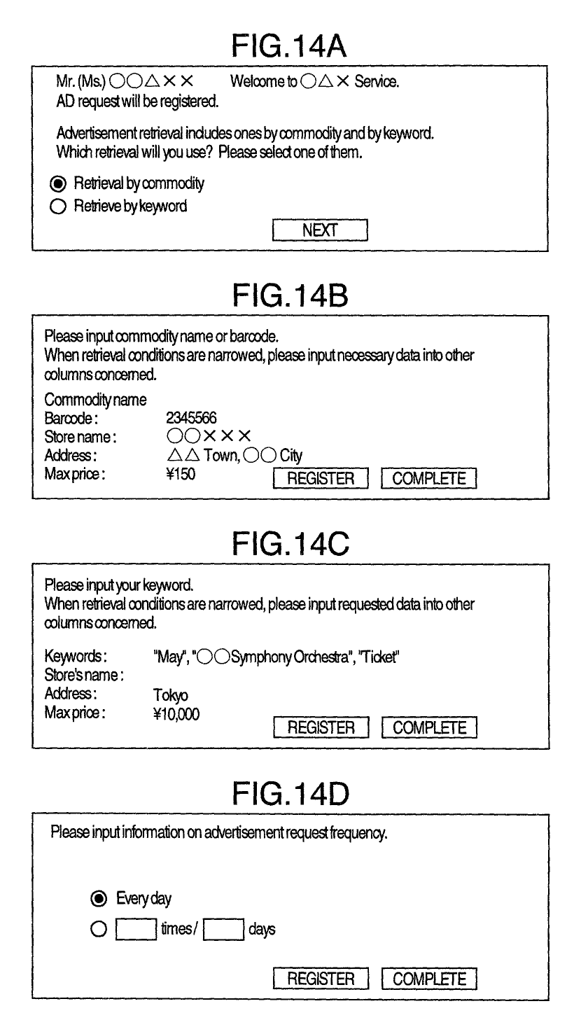

The advertisement request registration screen (FIG. 14A) displays select buttons “retrieve by commodity/store” and “retrieve by keyword”.

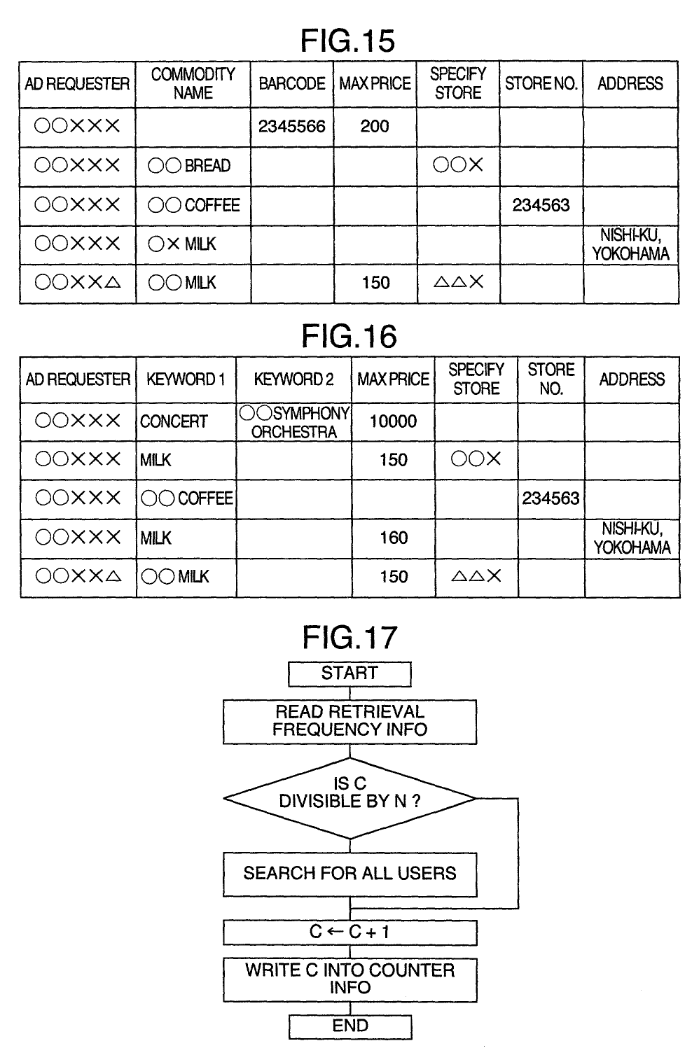

When the “retrieve by commodity/store” is selected, a screen of FIG. 14B is displayed to prompt the user to input commodity and store names. The contents of the request thus registered are stored in the advertisement request information storage device 42B. FIG. 15 illustrates a table of the stored data. Advertisement information such as “commodity name/barcode value/maximum price/store name/store number/store location area (address)” to be requested by each of the advertisement requesters is stored in correspondence to the advertisement requester. FIG. 14B illustrates “an advertisement publishing an article having a barcode value of 2345566 and a price of less than ¥150 is requested from a store located in ΔΔ Town, ∘∘ City”.

When “retrieve by keyword” is selected in FIG. 14A, a screen of FIG. 14C is displayed to prompt the user to input data on a keyword, store name, address, maximum sum, etc. The contents of the request thus registered are then stored in the advertisement request keyword information storage device 42A. FIG. 16 shows advertisement information “A plurality of keywords (a single keyword may be OK)/maximum price/store name/store number/store address” requested by each of the advertisement requesters is stored in correspondence to the advertisement requester. The example of FIG. 14C illustrates that the requester has requested an advertisement that has published a ticket of less than ¥10,000 for ∘∘ Symphony Orchestra's concert” to be held in May in Tokyo.

When the registration buttons of FIGS. 14A and 14B are depressed, the screen of FIGS. 14A and 14B are again displayed so that the next items of advertisement information may be input. When a complete button is depressed, a screen for inputting desired information delivery frequency (FIG. 14D) is displayed to prompt the user to input a frequency of delivering the advertisement information. Input areas for the frequencies “every day” and “∘ times/ΔΔ days” that the requester can input are provided so that the user may select one of them. The frequency information may be stored for each request inputted before, and the frequency may vary for each request.

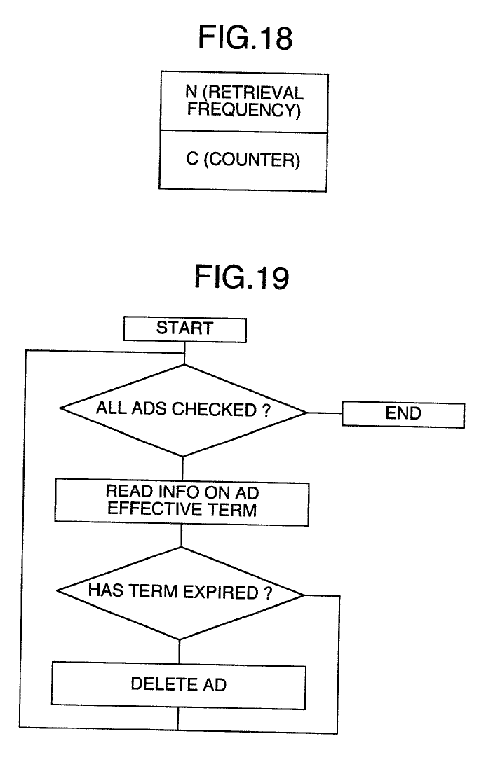

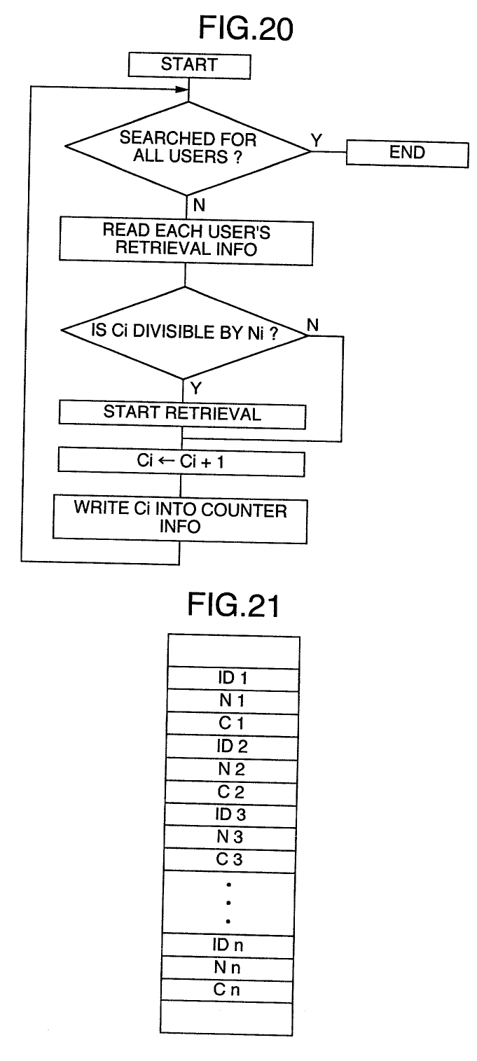

An advertisement information delivery performed by the server 3 based on the advertisement information thus registered and the advertisement request information will be described with reference to FIGS. 17, 18, 20 and 21. FIGS. 17 and 20 illustrate a flow of retrieval. FIGS. 18 and 21 illustrate one example of retrieval frequency information written into the retrieval frequency information storage device 45.

An example of retrieval performed when the case where the advertisement retrieval frequencies requested by all the advertisement requesters are the same will be explained with reference to FIGS. 17 and 18. A retrieval frequency is input to N in FIG. 18. For example, 2 is written in N when retrieval is made once every two days. A value of C is a count incremented by one every day. By setting in the controller 44 that retrieval should be made when the value of C is divisible by N, retrieval is made every N days. It was illustrated in FIG. 17 that the value of C was incremented one by one. A similar result is obtained when the remainder obtained by dividing the value of C by N is stored and a condition “C is divisible by N” is replaced by a condition “C=0”.

Alternatively, each requester may have a calendar on which after retrieval is made once the next retrieval day is set based on the frequency information. When the set day comes, the retrieval may start and the next retrieval day may also be set. Any method may be used that allows the requester to retrieve/deliver advertisement information at a desired frequency.

In a box “search for all users” of FIG. 17, an advertisement retrieval expression necessary for each advertiser is created for the advertisement requester by referring to data on the contents of an advertisement request of FIGS. 15 and 16. The retrieval expression may be OR operation among retrieval results of requests (for one line) of data of FIGS. 15 and 16. The commodity information database of FIG. 13 is searched for the desired data according to the created retrieval expression. Results of the search are collected for each advertisement requester, a mail address of the advertisement requester is called, and the searched advertisement data is delivered to the advertisement requester.

FIG. 20 illustrates the case where a retrieval frequency is set for each user. FIG. 20 is different from FIG. 17 in that the user's registration number (authentication number: ID) is added to the retrieval frequency information and that the values of N and C are set for each user. The retrieval method is the same as that shown in FIGS. 17 and 18, and is performed in accordance with a flow of FIG. 20, using values of Ci and Ni set for the user instead of the values of C and N. The retrieval frequency information used at this time is stored in a form shown in FIG. 21 in the storage device 45.

By the using the retrieval method of FIGS. 20 and 21, a plurality of courses may be set in the advertisement retrieval service to provide services that change the respective retrieval frequencies depending on the corresponding course fees. Classifying the courses depending on their fees is one example. The courses may be classified depending on the number of times, or the sum of money for which, the commodities were bought, using the advertisement service, or respective points set depending on the sum of money for which the commodities were bought.

FIG. 19 illustrates a method of deleting a registered advertisement based on an effective term or deadline of the advertisement set when the same was registered. Each advertisement registered in 41A had an effective term or deadline, for example, as shown in FIG. 13. The effective term or deadline is checked. That is, the check day information that the information processor has is compared with the deadline, and an advertisement whose term has expired is deleted.

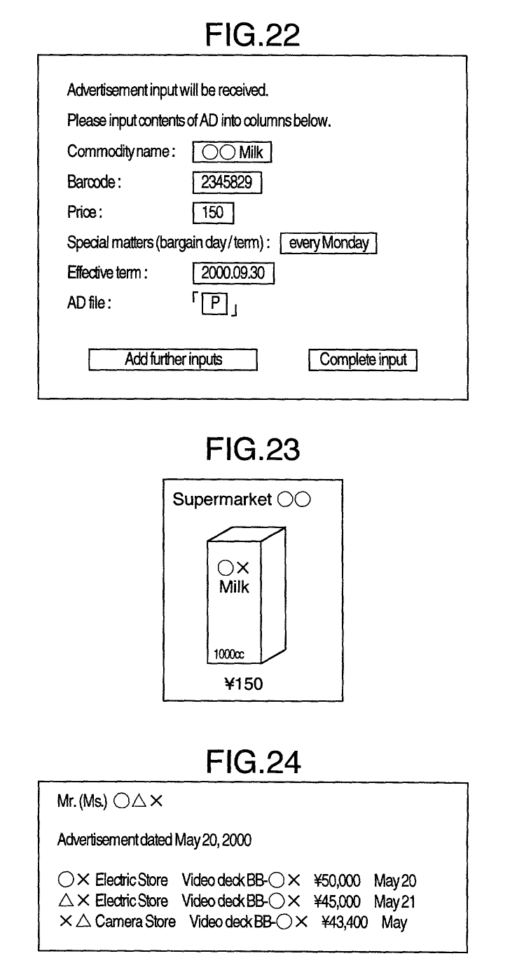

While in the above description the advertisement delivery service using an advertisement of only text information has been illustrated, an advertisement using prior art screens/photographs may be delivered. This will be described with reference to FIGS. 22 through 25.

FIG. 22 illustrates a guidance screen used when pictures/photographs are included in the registered information. Like the advertisement of only a text, a commodity's name, barcode and price, special matters representing a bargain day and a bargain term, an effective term or deadline of the advertisement, and an image file of the advertisement are attached. An example of the image file of the advertisement is shown in FIG. 23.

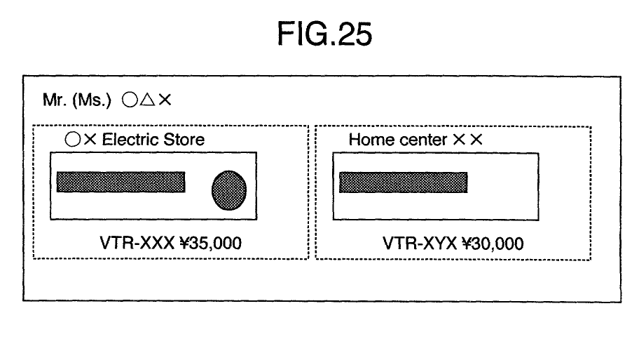

By making such advertisement registration, not only an advertisement of only a text shown in FIG. 24, but also an advertisement similar visually to a prior art page one and containing pictures, such as shown in FIG. 25, can be provided.

While in the above embodiment the advertisement information is illustrated as being registered in the storage device 3D of the server 3, an arrangement may be used in which the advertisement information is kept in a storage device of any one of the servers to be connected to the network or the storage device of the information processor without being registered in a specified server. In that case, the advertisement information delivery server 3 collects advertisement information that the user desires from the storage device connected to the network and sends the information to the requester at a predetermined timing.

While in the above embodiment the frequency information is illustrated as being used as the timing of retrieval, the retrieval itself may be performed at a predetermined timing, for example, once a day without resorting to the frequency information to thereby collect advertisement information, and the collected advertisement information may be delivered to the requester when a timing indicated by the frequency information has come. The frequency information may be used only to determine a timing of delivering the advertisement information to the requester, irrespective of the timing of retrieval.

While in the above embodiment a screen is displayed that prompts the user to input a frequency of delivering advertisement information, a predetermined frequency may be set as a default value, for example, like “advertisement information is delivered to the requester once a day when the advertisement requester inputs no frequency information” to allow the advertisement requester to omit inputting the frequency information. This applies to an effective term or deadline of the advertisement. While in the embodiment the advertisement requester is required also to input the effective term or deadline of the advertisement, a default value, for example, of one week from the day when other advertisement-related data is input may be set as the effective term or deadline if no effective term or deadline data is input, and checked in the retrieval.

While the advertisement information is illustrated as being delivered to a mail address specified when the advertisement requester was registered, an advertisement page for each requester may be created and published at an Internet address specified by the advertisement mediator in the registration so that the requester may see the advertisement, using Internet browsing software.

What is claimed is:

1. An electronic advertisement delivering method in a system where a user terminal is connected to a server via a transmission line, comprising the steps of:
storing advertisement information in a storage device of the server;
storing in the storage device of the server advertisement request information including an address of a destination to which advertisement is delivered, the address of a destination being inputted by the user terminal;
storing in the storage device of the server information on a frequency of retrieval execution;
retrieving and extracting from among the advertisement information an advertisement coinciding with the advertisement request information at a timing depending on the frequency information; and
delivering the extracted advertisement information to an address specified by an advertisement requester.

2. The electronic advertisement delivering method according to claim 1, wherein the advertisement information is inputted by the user terminal connected to the transmission line.

3. The electronic advertisement delivering method according to claim 1, wherein the advertisement information comprises a value of a barcode specifying a commodity.

4. The electronic advertisement delivering method according to claim 2, wherein the user terminal keeps a lookup table that indicates commodity codes and commodity names in corresponding relationship, and comprising the steps of:
adding to the lookup table information on whether the advertisement information should be published on the lookup table as the information to be stored in the storage device of the server; and
delivering resultant information to the server.

5. The electronic advertisement delivering method according to claim 1, wherein the advertisement request information comprises a keyword to a commodity or service that the advertisement requester desires.

6. The electronic advertisement delivering method according to claim 1, wherein retrieval frequency information is inputted from the user terminal.

7. The electronic advertisement delivering method according to claim 1, comprising the steps of:
adding at least information specifying an effective term or deadline to the advertisement information; and
deleting the advertisement information based on the information specifying the effective term or deadline of the advertisement.

8. The electronic advertisement delivering method according to claim 1, comprising the steps of:
using an advertisement design in the advertisement information; and
delivering advertisement information laid out by the advertisement design to the address of a destination inputted by the user terminal.

9. An electronic advertisement delivering method in a system where a user terminal is connected to a server via a transmission line, comprising the steps of:
storing advertisement information in a storage device of the server;
storing in the storage device of the server advertisement request information inputted by the user terminal;
storing in the storage device of the server information on a frequency of retrieval execution;
retrieving and extracting from among the advertisement information an advertisement coinciding with the advertisement request information at a timing depending on the frequency information; and
publishing the extracted advertisement on a home page of an internet address set for an advertisement requester.

10. An advertisement delivering method comprising of the steps:
displaying a screen on a user's terminal used by an advertisement information requester, the screen prompting the requester to input the contents of an advertisement request, an address of a destination to which the advertisement is to be delivered, and information on an advertisement delivery frequency;
collecting advertisements meeting the contents of the advertisement request inputted by the user terminal, at a timing depending on the delivery frequency information inputted by the user terminal; and
delivering the collected advertisement information to the address of a destination inputted by the user terminal.

11. An electronic advertisement delivering system comprising:
a user terminal for inputting the contents of an advertisement information request and an address of a destination to which the advertisement information is to be delivered; and
a server connected via a transmission line to the user terminal for collecting advertisement information coinciding with the contents of the advertisement request inputted by said user terminal and for sending the collected advertisement information at a predetermined frequency to the address of a destination inputted by said user terminal.

12. The electronic advertisement delivering system according to claim 11, wherein said user terminal further comprises for inputting information on an advertisement delivery frequency and for sending the advertisement at a frequency depending on the advertisement delivery frequency information inputted by said user terminal.

13. A server connected via a transmission line to a user terminal which requests advertisement information, comprising:
means for sending the user terminal a guide screen that prompts the user terminal to input the contents of an advertisement request and an address of a destination to which the advertisement is to be delivered;
means for collecting advertisement information coinciding with the contents of the input advertisement request; and
means for sending the collected advertisement information at a predetermined frequency to the inputted address of a destination to which the advertisement is to be delivered.

14. The advertisement delivery server according to claim 13, wherein the guide screen comprises guidance for inputting information on an advertisement delivery frequency.

15. An advertisement delivering method comprising of the steps:
displaying a screen on a user's terminal used by an advertisement information requester, the screen prompting the requester to input the contents of an advertisement request, an address of a destination to which the advertisement is to be delivered, and information on an advertisement delivery frequency;
collecting advertisements meeting the contents of the advertisement request inputted by the user terminal; and
delivering information on the collected advertisement to the address of a destination inputted by the user terminal at a timing depending on the delivery frequency information inputted by the user terminal.

16. An advertisement delivering method comprising of the steps:
displaying a screen on a user's terminal used by an advertisement information requester, the screen prompting the requester to input the contents of an advertisement request, and an address of a destination to which the advertisement is to be delivered;
collecting advertisements meeting the contents of the advertisement request inputted by the user terminal; and
delivering the collected advertisements to the address of a destination inputted by the user terminal.

17. The advertisement delivering method according to claim 16, wherein the collection of the advertisement that meets the contents of the advertisement request, and delivery of the collected advertisement at the predetermined timing are repeated at a predetermined frequency.

18. The advertisement delivering method according to claim 17, wherein the predetermined frequency is determined by frequency information inputted by the user terminal.

19. The advertisement delivering method according to claim 16, wherein the contents of the advertisement request inputted by the user terminal comprises a keyword to a commodity or service that the advertisement requester desires.

20. The advertisement delivering method according to claim 16, wherein advertisement information having an expired predetermined term is removed from the advertisement information to be delivered to the address of a destination.

21. The advertisement delivering method according to claim 16, wherein the contents of the advertisement request inputted by the user terminal comprises information on local area information as advertisement information.

22. A computer program product stored on a computer readable medium for delivering an electronic advertisement, the computer program product comprising:
a code for displaying a screen on a user terminal that an advertisement information requester uses, the screen prompting the requester to input the contents of an advertisement request and an address of a destination to which the advertisement is to be delivered; and
a code for delivering to the address of a destination at a predetermined timing advertisements collected in accordance with the contents of the advertisement request inputted by the user terminal.

23. The computer program product according to claim 22, wherein the collection of the advertisement that meets the contents of the advertisement request, and delivery of the collected advertisement at the predetermined timing are repeated at a predetermined frequency.

24. The computer program product according to claim 23, wherein the predetermined frequency is determined by frequency information inputted by the user terminal.

25. The computer program product according to claim 22, wherein the contents of the advertisement request inputted by the user terminal comprises a keyword to a commodity or service that the advertisement requester desires.

26. The advertisement delivering method according to claim 22, wherein advertisement information having an expired predetermined term is removed from the advertisement information to be delivered to the address of a destination.

27. The advertisement delivering method according to claim 22, wherein the contents of the advertisement request inputted by the user terminal comprises information on local area information as advertisement information.
